(19) United States
(12) Patent Application Publication
(10) Pub. No.: US 2014/0325323 A1
(43) Pub. Date: Oct. 30, 2014

(54) ONLINE VIDEO PLAYING METHOD AND APPARATUS AND COMPUTER READABLE MEDIUM

(71) Applicant: TENCENT TECHNOLOGY (SHENZHEN) COMPANY LIMITED, Shenzhen (CN)

(72) Inventors: Jing LIU, Shenzhen (CN); Xiaodan LIN, Shenzhen (CN)

(73) Assignee: TENCENT TECHNOLOGY (SHENZHEN) COMPANY LIMITED, Shenzhen (CN)

(21) Appl. No.: 14/258,937

(22) Filed: Apr. 22, 2014

Related U.S. Application Data
(63) Continuation of application No. PCT/CN2013/089107, filed on Dec. 11, 2013.

(30) Foreign Application Priority Data
Apr. 28, 2013 (CN) 201310157371.6

(51) Int. Cl. G06F 17/22

(52) U.S. Cl. CPC G06F 17/2247; G06F 17/2235
USPC 715/201

(57) ABSTRACT

The disclosure relates to mobile terminal technology field, and in particular, to an online video playing method, apparatus and computer-readable medium, the method comprising in response to detecting an access instruction to a video link on a webpage, scanning codes of the webpage; determining whether the codes of the webpage include a browser playing function, which is configured to generate a playing window with a predefined size in a browser to play the video; in response to the codes of the webpage include the browser playing function, acquiring a video content corresponding to the video link from a server indicated by the video link; invoking the browser playing function, generating the playing window with the predefined size in the browser, and playing the video content in the playing window with the predefined size.

### CROSS-REFERENCE TO RELATED APPLICATIONS

This application is a continuation application of PCT Patent Application No. PCT/CN2013/089107, entitled “Online Video Playing Method and Apparatus and Computer Readable Medium” filed on Dec. 11, 2013, which claims the priority benefit of Chinese Patent Application No. 201310157371.6, filed to Chinese Patent Office on Apr. 28, 2013, entitled “Online Video Playing Method and Apparatus,” the disclosures of which are herein incorporated by reference in their entireties.

### TECHNICAL FIELD

The disclosure relates to mobile terminal technology field and, in particular, to an online video playing method and apparatus and computer readable medium.

### BACKGROUND

Rapid development of the mobile Internet and rapid popularization of smart mobile terminals bring tremendous changes to human life; in terms of media transmission, users not only can review texts and pictures, and listen to music on the mobile terminals via the mobile Internet anytime and anywhere, but also can directly view online video on the mobile terminals; and now the mobile Internet is developing diversely and prosperously.

Nowadays, in response to a mobile terminal accessing a video link on a webpage through a browser, the browser needs to invoke a local system player of the mobile terminal, and the system player requests the loading of the corresponding video content from a video website server indicated by the video link, so as to carry out the playing of the online video. However, the system player must constantly play the online video on a full screen, which results in, during the playing of the online video, a window of the video player occupying the entire screen of the mobile terminal, and the browser's access to the webpage being interrupted; therefore, if the user wants to go on accessing the webpage, he/she has to pause the playing of the online video, and switch the browser to the foreground, which decreases the webpage browsing efficiency of the mobile terminal.

### SUMMARY

An embodiment of the invention is implemented as an online video playing method, comprising in response to detecting an access instruction to a video link on a webpage, scanning a code of the webpage; determining whether the code of the webpage includes a browser playing function, which is being configured to generate a playing window with a predefined size in the browser to perform the playing of the video; acquiring a video content corresponding to the video link from a server indicated by the video link if the code of the webpage includes the browser playing function; and invoking the browser playing function, generating the playing window with the predefined size in the browser, and playing the video content in the playing window with the predefined size.

Another embodiment of the invention is to provide an online video playing apparatus, comprising scanning unit, configured to scan a code of a webpage in response to detecting an access instruction to a video link on that webpage; determining unit, configured to determine whether the code of the webpage includes a browser playing function, the browser playing function being configured to generate a playing window with a predefined size in the browser to play a video; acquiring unit, configured in response to the code of the webpage including the browser playing function, acquiring a video content corresponding to the video link from a server indicated by the video link; and playing unit, configured to invoke the browser playing function, generate the playing window with the predefined size in the browser, and play the video content in the playing window with the predefined size.

Another embodiment of the invention is to provide a non-transitory computer readable medium, with a computer executable program stored thereon, whereby the computer executable program, when being run, executes an online video playing method, comprising steps in response to detecting an access instruction to a video link on a webpage, scanning a code of that webpage; determining whether the code of the webpage includes a browser playing function, which is configured to generate a playing window with a predefined size in the browser to play a video; in response to the code of the webpage including the browser playing function, acquiring a video content corresponding to the video link from a server indicated by the video link; and invoking the browser playing function, generating the playing window with the predefined size in the browser, and playing the video content in the playing window with the predefined size.

The embodiments of the invention provide an online video playing method, apparatus and computer readable medium based on a mobile terminal browser, which includes, during the browsing of a webpage via a browser, in response to accessing a video link on that webpage and playing an online video, using a browser playing function pre-embedded in webpage code, directly invoking the browser to generate a playing window with a predefined size to play the online video, so that the playing of the online video does not occupy the entire screen of the mobile terminal, and the network behaviors of the video viewing and webpage browsing can be smoothly switched, or can even be performed concurrently, thereby greatly increasing the network browsing efficiency of the mobile terminal.

### BRIEF DESCRIPTION OF THE DRAWINGS

The drawings described herein are for illustrative purposes only of selected embodiments and not all possible implementations, and are not intended to limit the scope of the present disclosure. Corresponding reference numerals indicate corresponding parts throughout the several views of the drawings.

FIG. 1 is a flowchart of an online video playing method by a mobile terminal provided by an embodiment of the invention;

FIG. 2 is a particular flowchart of step S103 of the online video playing method by the mobile terminal provided by the embodiment of the invention;

FIG. 3 is a particular flowchart of step S104 of the online video playing method by the mobile terminal provided by the embodiment of the invention;

FIG. 4A and FIG. 4B are diagrams of positions of a playing window of the online video playing method by the mobile terminal provided by the embodiment of the invention;

FIG. 5 is a flowchart of an online video playing method by a mobile terminal provided by another embodiment of the invention;

FIG. 6 is a structural diagram of an online video playing apparatus of a mobile terminal provided by an embodiment of the invention;

FIG. 7 is a diagram of an environmental scene in which embodiments of the invention are applied; and

FIG. 8 is a block diagram of an example of a mobile terminal in embodiments of the invention.

### DETAILED DESCRIPTION

To make the objects, solutions and advantages of the invention clearer, the invention will be described below in detail in combination with drawings and embodiments. It should be understood that the embodiments described herein are only to explain the invention, but not to limit the invention.

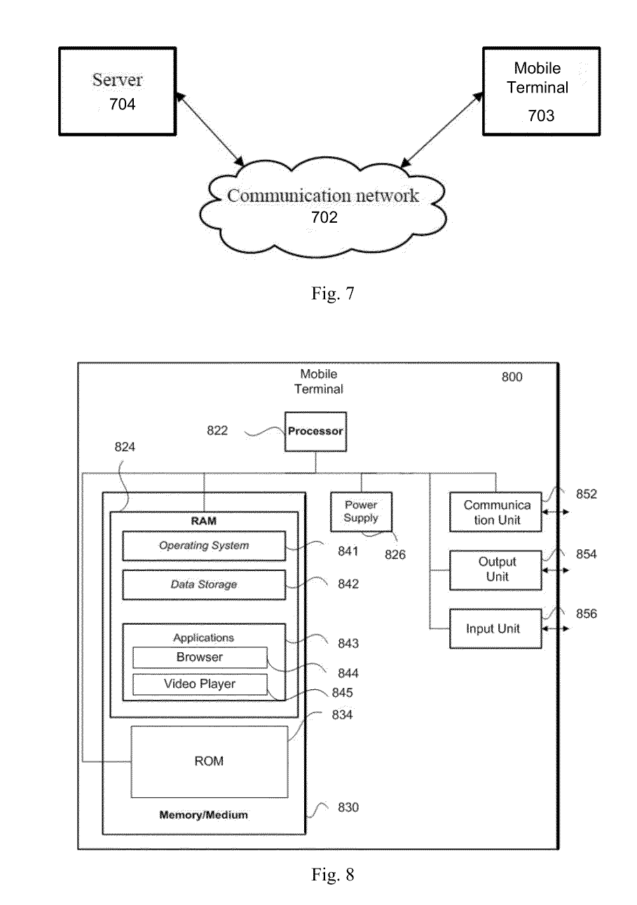

FIG. 7 is a diagram of an environmental scene in which embodiments of the invention are applied. The exemplary environment may include a server 704, a mobile terminal 703, and a communication network 702. The server and the mobile terminal may be coupled through the communication network for information exchange, such as sending/receiving identification information, sending/receiving data files, etc. Although only one mobile terminal and one server are shown in the environment, any number of terminals or servers may be included, as well as other devices. The communication network may include any appropriate type of communication network for providing network connections to the server and mobile terminal or among multiple servers or mobile terminals. For example, the communication network may include the Internet or other types of computer networks or telecommunication networks, either wired or wireless. In a certain embodiment, the disclosed methods and apparatus may be implemented, for example, in a wireless network that includes at least one mobile terminal.

FIG. 8 is a block diagram of an example of a mobile terminal in embodiments of the invention. As shown in FIG. 8, an example of a mobile terminal 800 may include a processor 822, a storage/medium 830 including Random Access Memory (RAM) 823, Read-Only Memory (ROM) 834, a power supply 826, a communication unit 852, an output unit 854, and an input unit 856. In the RAM 824, operating system 841, data storage 842, and applications 843 may be stored. The application programs 843 may include, for example, a browser 844, a video player 845, and so on. The input unit 856 may include a keyboard, a microphone and so on. The output unit 854 may include a display, a speaker and so on. The communication unit 852 may be in charge of communicating with the server 704 via the communication network 702 as shown in FIG. 7. The methods mentioned in this disclosure may be implemented by an application program in a mobile terminal.

The embodiments of the invention provide an online video playing method, apparatus and computer readable medium based on a mobile terminal browser, which includes, during the browsing of a webpage via a browser, in response to accessing a video link on that webpage and playing an online video, using a browser playing function pre-embedded in webpage code, directly invoking the browser to generate a playing window with a predefined size to play the online video, so that it is unnecessary to additionally invoke a local video player (or video playing application program) of the mobile terminal, and the playing of the online video does not occupy the entire screen of the mobile terminal, but only a part of the browser, and the network behaviors of the video viewing and webpage browsing can be smoothly switched, or can even be performed concurrently, thereby greatly increasing the network browsing efficiency of the mobile terminal. Of course, the above effects are only examples, not limitations.

The mobile terminal mentioned in the embodiments of the invention includes, but is not limited to, a smart mobile terminal device having mobile Internet accessing function, such as a mobile phone, a tablet, and so on, and a Wireless Application Protocol (WAP) browser (briefly referred to as the browser) suitable for the mobile terminal's operating system running environment is installed in the mobile terminal, for users to perform webpage browsing through the browser. In particular, examples of mobile terminals that can be used in accordance with various embodiments include, but are not limited to, a tablet PC (including, but not limited to, Apple iPad and other touch-screen devices running Apple iOS, Microsoft Surface and other touch-screen devices running the Windows operating system, and tablet devices running the Android operating system), a mobile phone, a smart phone (including, but not limited to, an Apple iPhone, a Windows Phone and other smart phones running Windows Mobile or Pocket PC operating systems, and smart phones running the Android operating system, the Blackberry operating system, or the Symbian operating system), an e-reader (including, but not limited to, Amazon Kindle and Barnes & Noble Nook), a laptop computer (including, but not limited to, computers running Apple Mac operating system, Windows operating system, Android operating system and/or Google Chrome operating system), or an on-vehicle device running any of the above-mentioned operating systems or any other operating systems, all of which are well known to those skilled in the art.

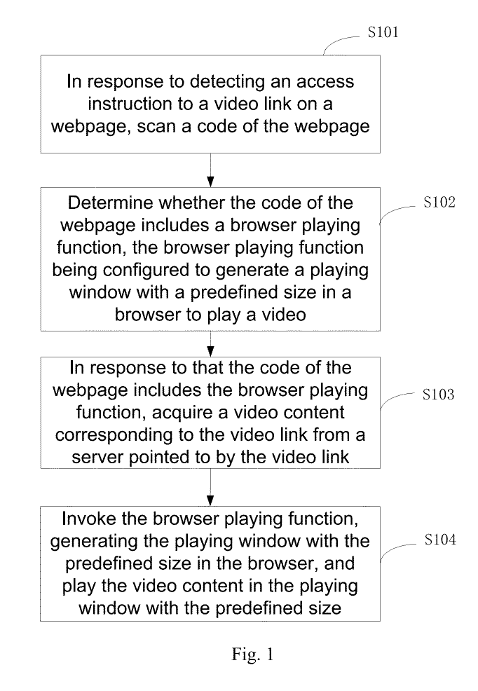

FIG. 1 is a flowchart of an online video playing method by a mobile terminal provided by an embodiment of the invention, in particular:

In step S101, in response to detecting an access instruction to a video link on a webpage, codes of the webpage are scanned.

In the embodiment, the webpage accessed by the browser of the mobile terminal includes a video link, for example, a video link provided by a specific video content publisher website or, for example, a link to a video report corresponding to a news content provided by a news webpage, and the video link can be rendered in the format of text, picture or touch button. The access instruction to the above video link can be detected by user events such as a click event, a touch event and so on.

All the webpages rendered on the browser interface exist in the format of background code, for example, a Hypertext Markup Language (HTML); and the browser reads the code and thereby renders the webpage. In the embodiment, in response to detecting the access instruction to the video link on the webpage, a scanning process on the webpage code is initiated.

In step S102, it is determined whether the code of the webpage includes a browser playing function, and the browser playing function is configured to generate a playing window with a predefined size in a browser to perform the playing of the video.

In the embodiment, the protocol specification of the mobile terminal browser provides a function of playing a video in a browser, and according to this protocol specification, a developer can predefine a browser playing function, which is to directly invoke the video playing feature of the browser during the browser's running, to generate the playing window with the predefined size so as to perform online video playing in the browser. Preferably, the browser playing function may be in a predefined javascript label, for the browser to invoke; i.e., before performing step S101, the javascript label including the browser playing function was predefined in the code of the webpage.

For example, the browser playing function QQB_playVideo (video_title, video_url, play_mode) is defined, in which the function name of the browser playing function is QQB playVideo, in which the parameter “video title” indicates the name of the video to be currently played, the parameter “video_url” is the Unified Resource Locator (URL) of the video to be currently played, i.e., the video link of the video to be currently played, and the parameter “play mode” is the predefined size for defining the playing window, for example, the parameter may take values as follows:

“play mode”=0, indicating that the playing window size is a default value for the browser;

“play mode”=1, indicating that the playing window is loaded as a full-screen playing mode; and

“play mode”=2, indicating that the playing window is loaded as a semi-screen playing mode.

Of course, the predefined size of the playing window is not limited to the above-exemplified values, but may be any suitable size. For example, the predefined size of the playing window may be covering ¾ of the screen of the browser, and so on.

If the browser playing function is:

QQBplayVideo (‘test video’, ‘http://www.gq.com/test.mp4’, 2), the function is to play a video called “test video” in the browser, whose playing mode is the semi-screen playing mode, and the address of the video is http://www.qq.com/test.mp4.

In the embodiment, after scanning the code of the webpage, it can be determined whether the code of the webpage includes the above-mentioned browser playing function and, if positive, step S103 is performed. For example, it is assumed that the code of the webpage includes “or href=“#” onClick=“QQBplayVideo (‘test videovideode://www.qq.com/test.mp4’,2); return false;”><img src=“logojpg”/></a>/a>>/a>; return false;“><img src=”logo.jpg”/><a>, it can be determined that the code of the webpage includes the above browser playing function, step S103 is performed.

In step S103, in response to the code of the webpage including the browser playing function, a video content corresponding to the video link is acquired from a server indicated by the video link.

If the code of the webpage including the video link includes the browser playing function, in response to accessing the video link therein, it is possible to prohibit the browser from invoking a local video player of the mobile terminal, but directly use the browser to play the video; at this time, the browser sends a request to the server indicated by the video link, and loads the video content corresponding to that video link.

Thereby, the video content corresponding to the video link is acquired by the browser directly from the server, and neither the video content request nor the playing process needs to invoke a video player of a third party, thereby increasing the efficiency of playing a video.

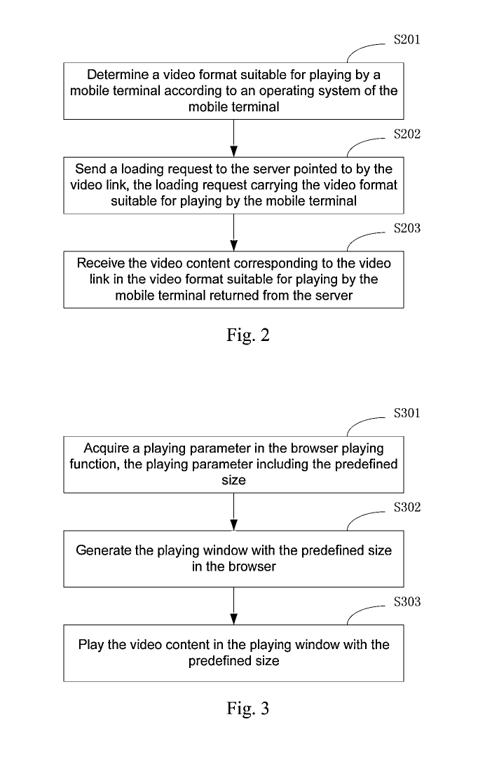

In particular, in an embodiment, step S103 may further include steps as shown in FIG. 2:

In step S201, a video format suitable for playing by a mobile terminal may be determined according to an operating system of that mobile terminal.

Typical video formats may include for example .mov, .mp4, .mpv and .3gp and so on with various compression standards, which will not be exemplified herein.

According to different operating systems of mobile terminals, the video formats which can be played on the mobile terminals may be different, for example, the IOS system can only play video files in a .mov format, but the Android system cannot play video files in a .mov format, so the video format suitable for the mobile terminal to play may be determined according to the operating system of that mobile terminal.

In step S202, a loading request may be sent to the server indicated by the video link, and the loading request carries the video format suitable for playing by the mobile terminal.

In this embodiment, according to the address path included in the video link, it is possible to address the server indicated by the video link, to send the loading request to the server. The sent loading request is used to acquire the video content corresponding to the video link from the server, and with the loading request carrying the video format suitable for the mobile terminal to play, it is possible to make the server return the video content in a correct video format, to carry out the video playing on the mobile terminal. Herein, the correct video format means the above-mentioned video format suitable for playing by the mobile terminal.

After the server receives the loading request, a storage address of the video content corresponding to the video link in the server is accurately addressed according to the video link in the loading request; meanwhile, the video content in a correct video format is extracted according to the video format required by the loading request, and returned to the mobile terminal.

In step S203, the video content corresponding to the video link with the video format suitable for playing by the mobile terminal returned from the server may be received.

Thereby, the browser can carry out the loading of the required video content.

In step S104, the browser playing function may be invoked, the playing window with the predefined size is generated in the browser, and the video content is played in the playing window with the predefined size.

In the embodiment, by invoking the browser playing function in the code of the webpage, the playing of the video content corresponding to the video link can be carry out. Herein, step S104 can be performed after step S103, i.e., performed after the video content required to play is completely loaded, or performed concurrently with step S103, i.e., playing the video content required to play while loading it.

In an embodiment, the generated playing window may be floating in front of the browser, while covering a part of content (in the case of half-screen playing mode) or the entire content (in the case of full-screen playing mode) originally displayed by the browser. In this case, the generated playing window and the browser are located in two different picture layers. In the case of the generated playing window covering a part of content originally displayed by the browser, a user may scroll to browse content displayed in other portions of the browser, which are not covered by the playing window while currently watching the video displayed in the playing window. In an embodiment, the generated playing window may be embedded into the browser without covering the content originally displayed by the browser.

In particular, step S104 may include steps as shown in FIG. 3:

In step 301, a playing parameter in the browser playing function may be acquired, and the playing parameter includes the predefined size.

The playing parameters in the browser playing function include the predefined size of the playing window and, in a particular implementation, the predefined size may include, but not limited to full-screen or semi-screen of the mobile terminal, whereby the playing window in full-screen mode will occupy the entire screen of the mobile terminal, and the playing window in semi-screen mode will occupy half of the screen of the mobile terminal. For example, the screen size of the mobile terminal may include 3.5-inch screen (about 7.4 cm long, and 4.96 cm wide), 4.3-inch screen (about 9.5 cm long, and 5.35 cm wide), 7-inch screen (about 17.8 cm long, and 12.7 cm wide) and so on, which are only examples, not limitations. Obviously, the predefined size may include different parameter values, to carry out the loading of the playing window with any self-defined size or proportion. The predefined size may include particular size and/or proportion. For example, in response to playing a video with normal standard definition, a predefined size of common proportion of 4:3 is used to generate the playing window; and in response to playing a video with high definition, a predefined size of proportion of 16:9 is used to generate the playing window. In the embodiment, in response to the predefined size being a non full-screen, the playing window may be a webpage frame embedded in the current webpage in the browser, or may be a webpage frame embedded in a separate browser page.

In step S302, the playing window with the predefined size may be generated in the browser.

For example, if the predefined size is the full-screen, a playing window occupying the entire screen of the mobile terminal is generated in the browser; if the predefined size is the semi-screen, a playing window occupying half of the screen of the mobile terminal is generated in the browser.

Further, as an embodiment of the invention, the playing parameters may further include a window position and, in particular, step S302 may include generating the playing window with the predefined size at the playing window position in the browser.

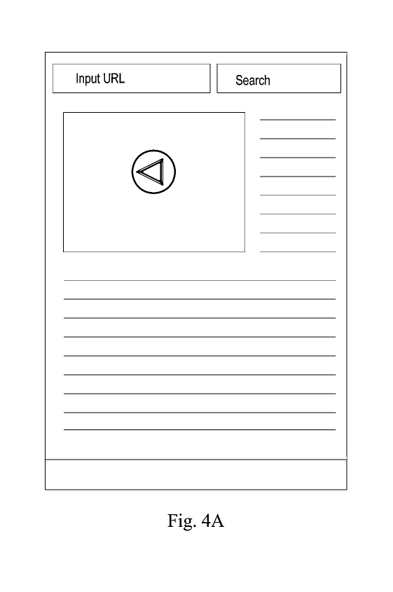

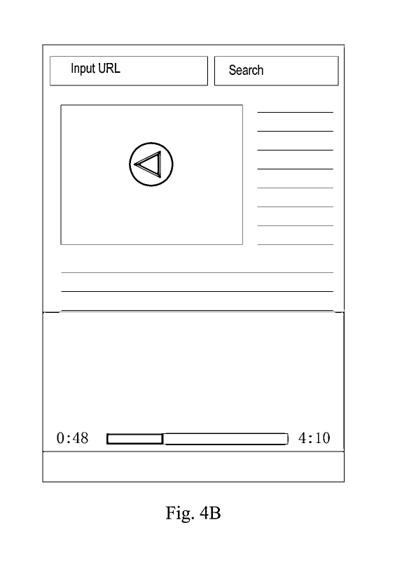

Thereby, it can be designated a certain position on the browser displaying interface where the playing window is generated, especially in response to playing an online video with a predefined size of non full-screen; as shown in FIG. 4, the original webpage displaying region without the playing window generated is as shown in FIG. 4A, while the webpage displaying region with the playing window generated is as shown in FIG. 4B, i.e., the lower half portion of the current webpage displaying region can be selected to load the video playing window, to play the online video, so as to avoid affecting the user's original webpage browsing, so that the user can browse the webpage content while loading the online video or even playing it.

In step S303, the video content may be played in the playing window with the predefined size.

By loading the video content acquired from the server to the playing window, it is possible to invoke the browser to play the video content corresponding to the video link, without switching to other independent players to play the online video which, on the one hand, omits the switch between applications which occupies system resources and increases the playing efficiency of the online video and, on the other hand, switches smoothly between the two Internet behaviors of viewing online videos and browsing webpages because of playing a video by a browser; and especially while playing a video in non full-screen mode. The above-mentioned two Internet behaviors can even be concurrently performed, which greatly increases the webpage browsing efficiency of the mobile terminal.

In another embodiment, after the playing window with the predefined size is generated at the playing window position in the browser, the position of the playing window may be further changed by dragging the playing window, and the size of the playing window may be further changed by a predefined gesture (for example, pressing the screen with two fingers while expanding with them).

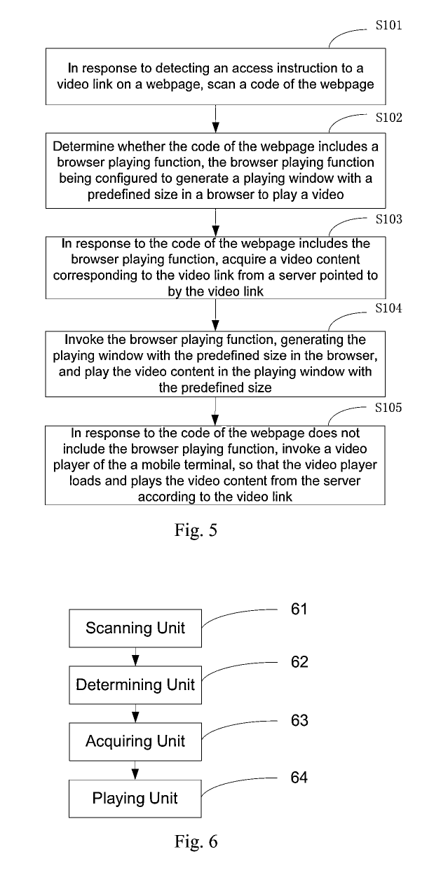

As an embodiment of the invention, as shown in FIG. 5, in response to the determination that the code of the webpage does not include the browser playing function in step S102, step S105 is performed by in response to the code of the webpage not including the browser playing function, invoking a video player of a mobile terminal, so that the video player loads and plays the video content from the server according to the video link.

At this time, it is indicated that the developer did not plant the browser playing function into the code of the webpage, and the video link on the webpage cannot be used to play an online video in the browser, so, according to the existing online video playing mode, a video player of the mobile terminal is invoked, to load the video content from the corresponding server according to the video link and play it.

FIG. 6 shows a structural diagram of an online video playing apparatus of a mobile terminal provided by an embodiment of the invention, in which the apparatus may be located in the mobile terminal system, for running the online video playing method by the mobile terminal of the embodiments of the invention of FIG. 1 to FIG. 5. To facilitate explanation, only the portions related to this embodiment are shown.

As shown in FIG. 6, the apparatus includes scanning unit 61, configured to scan a code of a webpage in response to detecting an access instruction to a video link on that webpage; determining unit 62, configured to determine whether the code of the webpage includes a browser playing function, which is configured to generate a playing window with a predefined size in the browser to play a video; acquiring unit 63, configured to acquire a video contact corresponding to the video link from a server indicated by the video link, in response to the code of the webpage including the browser playing function; and playing unit 64, configured to invoke the browser playing function, generate the playing window with the predefined size in the browser, and play the video content in the playing window with the predefined size.

Optionally, the apparatus may further include invoking unit, configured to, in response to the code of the webpage not including the browser playing function, invoke a video player of a mobile terminal, so that the video player loads and plays the video content from the server according to the video link.

Optionally, the apparatus may further include predefining unit, configured to presetting a javascript label including the browser playing function in the code of the webpage.

Optionally, the acquiring unit 63 includes determining subunit, configured to determine a video format suitable for playing by a mobile terminal according to an operating system of that mobile terminal; sending subunit, configured to send a loading request to the server indicated by the video link, the loading request carrying the video format suitable for playing by the mobile terminal; receiving subunit, configured to receive the video content corresponding to the video link with the video format suitable for playing by the mobile terminal from the server.

Optionally, the playing unit 64 may include acquiring subunit, configured to acquire a playing parameter in the browser playing function, the playing parameter including the predefined size; generating subunit, configured to generate the playing window with the predefined size in the browser; and playing subunit, configured to play the video content in the playing window with the predefined size.

Optionally, the playing parameter may further include a playing window position, and the generating subunit is configured to generate the playing window with the predefined size at the playing window position in the browser.

In some implementations, the memory or the non-transitory computer readable storage medium of the memory stores the following programs, modules and data structures, or a subset thereof including an operating system, a network communication module, scanning unit, configured to scan a code of a webpage when detecting an access instruction to a video link on webpage; determining unit, configured to determine whether the code of the webpage includes a browser playing function, which is configured to generate a playing window with a predefined size in the browser to play a video; acquiring unit, configured to when the code of the webpage includes the browser playing function, acquiring a video content corresponding to the video link from a server indicated by the video link; playing unit, configured to invoke the browser playing function, generating the playing window with the predefined size in the browser, and playing the video content in the playing window with the predefined size.

The embodiments of the invention provide an online video playing method, apparatus and computer readable medium based on a mobile terminal browser, which includes, during the browsing of a webpage via a browser, in response to accessing a video link on that webpage and playing an online video, using a browser playing function pre-embedded in webpage codes, directly invoking the browser to generate a playing window with a predefined size to play the online video, so that it is unnecessary to additionally invoke a local video player (or video playing application program) of the mobile terminal, and the playing of the online video does not occupy the entire screen of the mobile terminal, but only a part of the browser, and the network behaviors of the video viewing and webpage browsing can be smoothly switched, or can even be performed concurrently, thereby greatly increasing the network browsing efficiency of the mobile terminal. Of course, the above effects are only examples, not limitations.

Reference throughout this specification to “one embodiment,” “an embodiment,” “specific embodiment,” or the like in the singular or plural means that one or more particular features, structures, or characteristics described in connection with an embodiment is included in at least one embodiment of the present disclosure. Thus, the appearances of the phrases “in one embodiment” or “in an embodiment,” “in a specific embodiment,” or the like in the singular or plural in various places throughout this specification are not necessarily all referring to the same embodiment. Furthermore, the particular features, structures, or characteristics may be combined in any suitable manner in one or more embodiments.

The terminology used in the description of the invention herein is for the purpose of describing particular examples only and is not intended to be limiting of the invention. As used in the description of the invention and the appended claims, the singular forms “a,” “an,” and “the” are intended to include the plural forms as well, unless the context clearly indicates otherwise. Also, as used in the description herein and throughout the claims that follow, the meaning of “in” includes “in” and “on” unless the context clearly dictates otherwise. It will also be understood that the term “and/or” as used herein refers to and encompasses any and all possible combinations of one or more of the associated listed items. It will be further understood that the terms “may include,” “including,” “comprises,” and/or “comprising,” when used in this specification specify the presence of stated features, operations, elements, and/or components, but do not preclude the presence or addition of one or more other features, operations, elements, components, and/or groups thereof.

The above description is only to describe preferable embodiments of the invention, but not to limit the invention, and any modification, equivalent alternation, and improvement and so on made within the spirit and principle of the invention are included in the protection scope of the invention.

What is claimed is:

1. An online video playing method, comprising:
in response to detecting an access instruction to a video link on a webpage, scanning a code of the webpage;
determining whether the code of the webpage comprises a browser playing function, the browser playing function being configured to generate a playing window with a predefined size in a browser to play a video;
acquiring a video content corresponding to the video link from a server pointed to by the video link if the code of the webpage includes the browser playing function; and
invoking the browser playing function, generating the playing window with the predefined size in the browser, and playing the video content in the playing window with the predefined size.

2. The method of claim 1, further comprising:
in response to that the code of the webpage does not include the browser playing function, invoking a video player of a mobile terminal, so that the video player loads and plays the video content from the server according to the video link.

3. The method of claim 1, further comprising before detecting an access instruction to a video link on a webpage, presetting a javascript label including the browser playing function in the code of the webpage.

4. The method of claim 1, wherein the step of acquiring a video content corresponding to the video link from a server pointed to by the video link comprises:
determining a video format suitable for playing by a mobile terminal according to an operating system of the mobile terminal;
sending a loading request to the server pointed to by the video link, the loading request carrying the video format suitable for playing by the mobile terminal; and
receiving the video content corresponding to the video link in the video format suitable for playing by the mobile terminal returned from the server.

5. The method of claim 1, wherein the step of invoking the browser playing function, generating the playing window with the predefined size in the browser, and playing the video content in the playing window with the predefined size comprises:
acquiring a playing parameter in the browser playing function, the playing parameter including the predefined size;
generating the playing window with the predefined size in the browser; and
playing the video content in the playing window with the predefined size.

6. The method of claim 5, wherein the playing parameter further comprises a playing window position, and the step of generating the playing window with the predefined size in the browser comprises:
generating the playing window with the predefined size at the playing window position in the browser.

7. The method of claim 1, wherein a local video player of a mobile terminal is not invoked in response to that the code of the webpage includes the browser playing function.

8. The method of claim 1, wherein the generated playing window is floating in front of the browser.

9. An online video playing apparatus, comprising:
scanning unit, configured to in response to detecting an access instruction to a video link on a webpage, scan a code of the webpage;
determining unit, configured to determine whether the code of the webpage includes a browser playing function, the browser playing function being configured to generate a playing window with a predefined size in a browser to play a video;
acquiring unit, configured to in response to that the code of the webpage includes the browser playing function, acquire a video content corresponding to the video link from a server pointed to by the video link;
playing unit, configured to invoke the browser playing function, generate the playing window with the predefined size in the browser, and play the video content in the playing window with the predefined size.

10. The apparatus of claim 9, further comprising:
invoking unit, configured to in response to that the code of the webpage does not include the browser playing function, invoke a video player of a mobile terminal, so that the video player loads and plays the video content from the server according to the video link.

11. The apparatus of claim 9, further comprising predefining unit, configured to predefine a javascript label including the browser playing function in the code of the webpage.

12. The apparatus of claim 9, wherein the acquiring unit includes:
determining subunit, configured to determine a video format suitable for playing by a mobile terminal according to an operating system of the mobile terminal;
sending subunit, configured to send a loading request to the server pointed to by the video link, the loading request carrying the video format suitable for playing by the mobile terminal; and
receiving subunit, configured to receive the video content corresponding to the video link in the video format suitable for playing by the mobile terminal returned from the server.

13. The apparatus of claim 9, wherein the playing unit comprises:
acquiring subunit, configured to acquire a playing parameter in the browser playing function, the playing parameter including the predefined size;
generating subunit, configured to generate the playing window with the predefined size in the browser; and
playing subunit, configured to play the video content in the playing window with the predefined size.

14. The apparatus of claim 13, wherein the playing parameter includes a playing window position, and the generating subunit is configured to generate the playing window with the predefined size at the playing window position in the browser.

15. The apparatus of claim 9, wherein a local video player of a mobile terminal is not invoked in response to that the code of the webpage includes the browser playing function.

16. The apparatus of claim 9, wherein the generated playing window is floating in front of the browser.

17. A non-transitory computer readable medium, with a computer executable program stored thereon, the computer executable program, when being run, executes an online video playing method, comprising:
in response to detecting an access instruction to a video link on a webpage, scanning a code of the webpage;
determining whether the code of the webpage includes a browser playing function, the browser playing function being configured to generate a playing window with a predefined size in a browser to play a video;
in response to that the code of the webpage includes the browser playing function, acquiring a video content corresponding to the video link from a server pointed to by the video link; and
invoking the browser playing function, generating the playing window with the predefined size in the browser, and playing the video content in the playing window with the predefined size.
